(19) United States
(12) Patent Application Publication
(10) Pub. No.: US 2025/0294223 A1
(43) Pub. Date: Sep. 18, 2025

(54) INFORMATION PROCESSING DEVICE, INFORMATION PROCESSING METHOD, AND RECORDING MEDIUM

(71) Applicant: Sony Group Corporation, Tokyo (JP)

(72) Inventors: Takayoshi SHIMIZU, Chiba (JP); Nana OKIMURA, Tokyo (JP)

(73) Assignee: Sony Group Corporation, Tokyo (JP)

(21) Appl. No.: 18/862,579

(22) PCT Filed: Apr. 17, 2023
(86) PCT No.: PCT/JP2023/015342

§ 371 Date: Nov. 4, 2024

(30) Foreign Application Priority Data
Jun. 3, 2022 (JP) 2022-090823

(51) Int. Cl. H04N 21/4788; H04N 21/2187; H04N 21/258; H04N 21/422

(52) U.S. Cl. CPC H04N 21/4788; H04N 21/2187; H04N 21/25866; H04N 21/42204

(57) ABSTRACT

[Problem] To realize bidirectional communication between a user and a distributor in a livestream.

[Solution] An information processing device including: a communication unit that sends distribution content, provided by a distributor, to a plurality of user terminals; a group selection unit that selects a first group, from among a plurality of groups to each of which two or more users belong, the first group being one group or two or more groups; and a connection control unit that controls a connection to enable bidirectional communication between the users belonging to the first group and the distributor.

### TECHNICAL FIELD

The present disclosure relates to an information processing device, an information processing method, and a recording medium.

### BACKGROUND ART

Livestreaming techniques, in which a distributor streams content to users in real time, have spread in recent years. In a livestream, the reactions of users can be fed back to performers, which enables users to enjoy a sense of immersion. For example, PTL 1 discloses a technique in which response data indicating actions and emotions of viewer (user) avatars with respect to actions of a performer (distributor) avatar is fed back to the performer (distributor) in the form of a display, tactile feedback, or the like.

### CITATION LIST

### Patent Literature

[PTL 1]
JP 2021-77257A

### SUMMARY

### Technical Problem

There is demand for enabling bidirectional communication between the user and the distributor in order to further improve the value of the user's experience. However, there are limited resources in terms of the number of channels over which bidirectional communication is possible, with respect to the number of channels over which distribution content can be viewed.

Accordingly, the present disclosure proposes a new and improved information processing device, information processing method, and recording medium that realize bidirectional communication between a user and a distributor in a livestream.

### Solution to Problem

To solve the aforementioned problem, according to one aspect of the present invention, an information processing device is provided, the information processing device including: a communication unit that sends distribution content, provided by a distributor, to a plurality of user terminals; a group selection unit that selects a first group, from among a plurality of groups to each of which two or more users belong, the first group being one group or two or more groups; and a connection control unit that controls a connection to enable bidirectional communication between the users belonging to the first group and the distributor.

Additionally, according to the present disclosure, an information processing method executed by a computer is provided, the method including: distributing distribution content, provided by a distributor, to a plurality of user terminals; selecting a first group, from among a plurality of groups to each of which two or more users belong, the first group being one group or two or more groups; and controlling a connection to enable bidirectional communication between the users belonging to the first group and the distributor.

Additionally, according to the present disclosure, a computer-readable non-transitory recording medium is provided, the recording medium having recorded thereon a program for causing a computer to function as: a distribution unit that distributes distribution content, provided by a distributor, to a plurality of user terminals; a group selection unit that selects a first group, from among a plurality of groups to each of which two or more users belong, the first group being one group or two or more groups; and a connection control unit that controls a connection to enable bidirectional communication between the users belonging to the first group and the distributor.

### BRIEF DESCRIPTION OF DRAWINGS

FIG. 1 is an explanatory diagram illustrating an overview of an information processing system according to the present disclosure.

FIG. 2 is a diagram illustrating an image of bidirectional communication by a distribution server 30 according to the present disclosure.

FIG. 3 is a block diagram illustrating an example of the configuration of a distributor terminal 10 according to an embodiment.

FIG. 4 is a block diagram illustrating an example of the configuration of a user terminal 20 according to the embodiment.

FIG. 5 is a block diagram illustrating an example of the configuration of the distribution server 30 according to the embodiment.

FIG. 6 is an explanatory diagram illustrating a specific example of connection control by a connection control unit 324.

FIG. 7 is an explanatory diagram illustrating screen images in each terminal in the specific example illustrated in FIG. 6.

FIG. 8 is an explanatory diagram illustrating another specific example of connection control by the connection control unit 324.

FIG. 9 is a flowchart illustrating an example of operations by the distribution server 30 according to the embodiment.

FIG. 10 is a flowchart illustrating an example of operations for implementing bidirectional communication controlled by the distribution server 30 according to the embodiment.

FIG. 11 is an explanatory diagram illustrating an example of screen images in each terminal in a first variation of the present disclosure.

FIG. 12 is a flowchart illustrating an example of operations for implementing bidirectional communication controlled by the distribution server 30 according to the first variation of the present disclosure.

FIG. 13 is a block diagram illustrating an example of the hardware configuration of an information processing device 900 which realizes the distributor terminal 10, the user terminal 20, and the distribution server 30 according to the embodiment of the present disclosure.

### DESCRIPTION OF EMBODIMENTS

A preferred embodiment of the present disclosure will be described in detail hereinafter with reference to the accompanying drawings. Note that in the present specification and the drawings, components having substantially the same functional configurations will be denoted by the same reference numerals, and repeated descriptions thereof will be omitted.

Further, in the present specification and drawings, multiple constituent elements having substantially the same functional configurations may be distinguished by appending different numbers or hyphens and numbers to like reference signs.

However, when there is no particular need to distinguish individual constituent elements having substantially the same functional configurations, those constituent elements will simply be given the same reference signs.

The descriptions will be given in the following order.
1. Overview of Information Processing System According to One Embodiment of Present Disclosure
2. Example of Functional Configurations in Embodiment
2-1. Example of Functional Configuration of Distributor Terminal 10
2-1. Example of Functional Configuration of User Terminal 20
2-2. Example of Functional Configuration of Distribution Server 30
3. Example of Operation Processing According to Embodiment
4. Example of Actions and Effects of Embodiment
5. Variations on Embodiment
5-1. First Variation
5-2. Second Variation
5-3. Third Variation
5-4. Other Variations
6. Hardware Configuration
7. Supplements

### 1. OVERVIEW OF INFORMATION PROCESSING SYSTEM ACCORDING TO ONE EMBODIMENT OF PRESENT DISCLOSURE

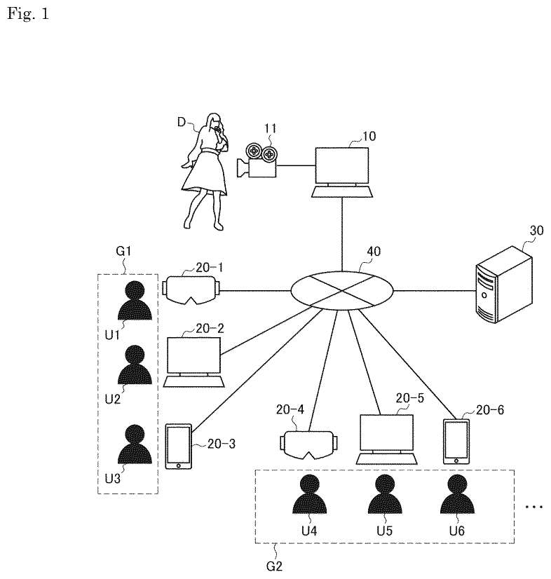

One embodiment of the present disclosure relates to an information processing system including an information processing device capable of improving the value of a user's experience in a livestream. The present embodiment will describe an information processing system that sends distribution content provided by a distributor to a user. The distribution content provided by the distributor is, for example, entertainment content such as live music, a comedy act, or an online game, distance learning content, remote support content, remote training lessons, or the like, and the details of the content are not limited. The information processing system according to the present disclosure will be described hereinafter with reference to FIG. 1.

FIG. 1 is an explanatory diagram illustrating an overview of the information processing system according to the present disclosure. As illustrated in FIG. 1, the information processing system according to the present disclosure includes a distributor terminal 10 used by a distributor D, a plurality of user terminals 20 used by corresponding ones of a plurality of users U, and a distribution server 30. As illustrated in FIG. 1, the distributor terminal 10, the user terminals 20, and the distribution server 30 are configured to be capable of communicating over a network 40. Each of the users U belongs to one group G among a plurality of groups G.

The distributor terminal 10 is an information processing terminal used by the distributor D. Video, audio, text, or motion is input to the distributor terminal 10. The distributor terminal 10 sends information indicating the input video, audio, text, motion, or the like to the distribution server 30.

Note that the distributor terminal 10 may be constituted by a plurality of information processing terminals, or may be a single information processing terminal. In the example illustrated in FIG. 1, the distributor terminal 10 is a personal computer (PC), and a camera 11 is connected to the distributor terminal 10. The distributor terminal 10 illustrated in FIG. 1 sends image data of the distributor D obtained by the camera 11 to the distribution server 30. Note that the distributor terminal 10 may be configured as a single device, such as a tablet terminal, a smartphone, a head-mounted display (HMD), a game console, a television, a wearable device, a motion capture device, a microphone, or the like, or as a combination of these various devices. Although the foregoing described an example in which the camera 11 is connected to the distributor terminal 10, the functions of the camera 11 may be built into the distributor terminal 10.

The user terminal 20 is an information processing terminal used by the user U. Video, audio, text, or motion is input to the user terminal 20. The user terminal 20 sends information indicating the input video, audio, text, motion, or the like to the distribution server 30. The user terminal 20 receives distribution content provided by the distributor D from the distribution server 30. The user terminal 20 also executes output processing for enabling the user U to view the distribution content received from the distribution server 30.

In the example illustrated in FIG. 1, a user U1 uses a user terminal 20-1. Likewise, a user U2 uses a user terminal 20-2, and a user U3 uses a user terminal 20-3. The users U1 to U3 may be viewing the distribution content at different locations from each other, or may be viewing the distribution content at the same location. Note that the user terminal 20 may be constituted by a plurality of information processing terminals, or may be a single information processing terminal. FIG. 1 illustrates an example in which the user terminal 20-1 is an HMD, the user terminal 20-2 is a PC, and the user terminal 20-3 is a smartphone. Aside from the example illustrated in FIG. 1, each user terminal 20 may be configured as a single device, such as a tablet terminal, a game console, a television, a wearable device, a camera, a motion capture device, a microphone, or the like, or as a combination of these various devices.

Each of the users U using the user terminals 20 belongs to one group G among a plurality of groups G. In the example illustrated in FIG. 1, the users U1, U2, and U3 belong to a group G1. Users U4, U5, and U6 belong to a group G2. Although three users belong to each group G in the example illustrated in FIG. 1, the number of users U belonging to each group G may be any desired number of at least 2. The number of users U belonging to the group G may be a number suitable for communication, for example, such as three to six. The number of users U belonging to the group G may be different in each group G. The number of groups G, too, is not particularly limited, and may be determined in accordance with the number of users U.

The distribution server 30 is an information processing device that sends the distribution content provided by the distributor D to the user terminals 20. The distribution content sent to the user terminals 20 may be data such as video, audio, text, or the like sent from the distributor terminal 10. The distribution server 30 may also send information on a virtual space, as well as information on a distributor object corresponding to the distributor D and disposed in the virtual space, to the user terminals 20 as the distribution content. The distribution server 30 can implement a livestream by sending the distribution content provided by the distributor D to the user terminals 20 in real time. The distribution server 30 may implement a livestream by sending the information on the virtual space to the user terminals 20 in advance, and then send the information on the distributor object to the user terminals 20 in real time.

### (Clarification of Issues)

According to the information processing system described above, a livestream can be performed by sending the distribution content provided by the distributor D to the plurality of user terminals 20 in real time. Here, there is demand for enabling bidirectional communication between the users U and the distributor D in order to further improve the value of the experience for the users U. However, there are limited resources in terms of the number of channels over which bidirectional communication is possible, with respect to the number of channels over which distribution content can be viewed.

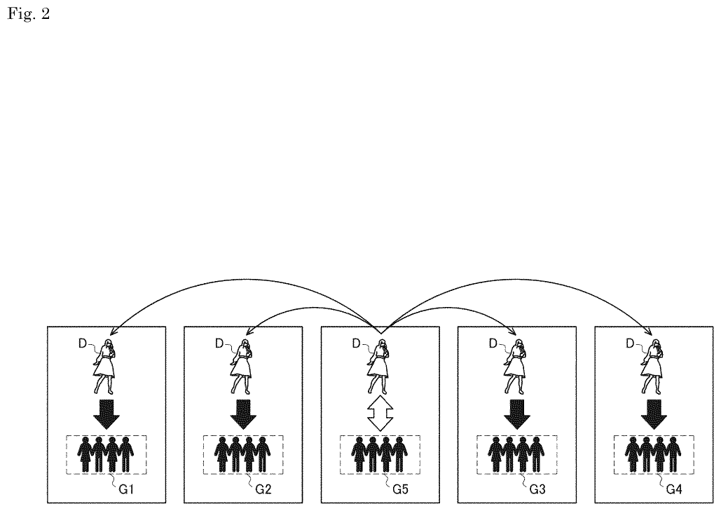

Accordingly, the distribution server 30 in the embodiment according to the present disclosure controls communication such that the users U belonging to a given group G and the distributor D can communicate with each other bidirectionally. FIG. 2 is a diagram illustrating an image of the bidirectional communication by the distribution server 30 according to the present disclosure. In FIG. 2, a conventional unidirectional distribution is provided to the users U belonging to groups G1 to G4. However, distribution that provides a special experience, namely that bidirectional communication with the distributor D is possible, is provided to the users U belonging to a group G5. While the experience of the users U belonging to the groups G1 to G4 is an experience like viewing an avatar of the distributor D, the experience of the users U belonging to the group G5 is an experience like viewing the actual distributor D him/herself, in which bidirectional communication with the distributor D is possible. Bidirectional communication with the distributor D in real time gives the user U the opportunity to be noticed by the distributor D. The distribution server 30 of the embodiment according to the present disclosure can therefore fulfill the needs of users who cannot participate in events held offline.

Returning to the descriptions of the distribution server 30 referring to FIG. 1, the distribution server 30 selects one, or two or more, of the groups G from among the plurality of groups G. The distribution server 30 may implement the bidirectional communication between the users U and the distributor D by sending data such as video, audio, text, and the like, sent from the users U belonging to the selected group G, to the distributor terminal 10. The distribution server 30 may also implement the bidirectional communication between the users U and the distributor D by sending information on user objects corresponding to the users U, sent from the users U belonging to the selected group G, to the distributor terminal 10.

The foregoing has given an overview of the information processing system according to one embodiment of the present disclosure. The specific configuration of each device included in the information processing system according to the present embodiment will be described next with reference to the drawings.

### 2. EXAMPLE OF FUNCTIONAL CONFIGURATIONS IN EMBODIMENT

### <2-1. Example of Functional Configuration of Distributor Terminal 10>

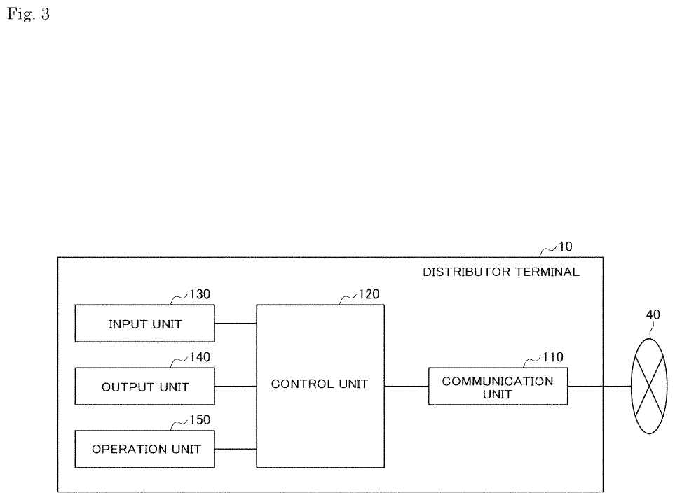

The configuration of the distributor terminal 10 used when the distributor D provides the distribution content will be described first with reference to FIG. 3.

FIG. 3 is a block diagram illustrating an example of the configuration of the distributor terminal 10 according to the present embodiment. As illustrated in FIG. 3, the distributor terminal 10 includes a communication unit 110, a control unit 120, an input unit 130, an output unit 140, and an operation unit 150.

### (Communication Unit)

The communication unit 110 communicatively connects with the distribution server 30, and exchanges data therewith. For example, the communication unit 110 sends information indicating video, audio, or motion information obtained by the input unit 130, information such as text input to the operation unit 150, or information on the distributor object corresponding to the distributor D, to the distribution server 30. The communication unit 110 also receives information indicating video, audio, or text, information on user objects corresponding to the users U, information on the virtual space, and the like from the distribution server 30.

### (Control Unit)

The control unit 120 controls the overall operations of the distributor terminal 10. For example, the control unit 120 causes the communication unit 110 to send the information indicating video, audio, motion, or the like obtained by the input unit 130, the information such as text input to the operation unit 150, and the like. The control unit 120 also causes the output unit 140 to output information such as the video, audio, text, virtual space, and the like received from the distribution server 30 by the communication unit 110.

The control unit 120 generates the information on the distributor object based on the information indicating the video, motion, or the like input to the input unit 130. The distributor object may be, for example, a 3D or 2D photorealistic avatar, or may be a 3D or 2D CG character.

The control unit 120 also updates the information on the distributor object based on motion information, which is the information on motion input to the input unit 130. For example, if motion information on the hands of the distributor D is input to the input unit 130, the control unit 120 updates the information on the distributor object such that the hands of the distributor object move. If motion information on the face of the distributor D is input to the input unit 130, the control unit 120 may update the information on the distributor object such that expression of the distributor object changes.

The control unit 120 may hold the information on the virtual space received from the distribution server 30. The control unit 120 may also perform processing for generating information on a new virtual space by disposing the distributor object indicated by the information on the generated distributor object in the virtual space. Furthermore, the control unit 120 may perform processing for generating information on a new virtual space by disposing the user objects indicated by the information on the user objects received by the communication unit 210 in the virtual space.

The control unit 120 may generate the information on the virtual space in which the user objects are disposed from the viewpoint of the distributor object. The virtual space from the viewpoint of the distributor object may or may not include the distributor object.

### (Input Unit)

The input unit 130 obtains information indicating video, audio, text, motion, or the like detected by a sensor. For example, the input unit 130 may obtain information detected by a sensor such as a camera, a microphone, a keyboard, a mouse, a touchpad, an inertial measurement unit (IMU), an IR sensor, a biosensor, or the like.

The input unit 130 obtains video of the distributor D captured by the camera 11, for example. The input unit 130 may also obtain the voice of the distributor D or sounds produced by the distributor D detected by a microphone. The input unit 130 may also obtain information on the distributor object in the virtual space, input by the distributor D and detected by a keyboard, e.g., location information or motion information on the distributor object, information on the possessions of the distributor object, and the like. The input unit 130 may also obtain information on the motion of the distributor D (position, posture, arm and leg motion, head motion, and the like), detected by the IMU, or obtain information on motion of the face (motion of the eyes, eyebrows, mouth and the like) of the distributor D, motion of the gaze of the distributor D, and the like obtained by the camera. Note that the input unit 130 may obtain information input by a plurality of types of sensors.

### (Output Unit)

The output unit 140 has a function of outputting information such as the information received from the distribution server 30 by the communication unit 110. For example, the output unit 140 may be implemented as a 2D display, a 3D display, a projector, a stereo hologram presentation device, or the like. The output unit 140 may, for example, display the information on the virtual space on a 2D display as video. The output unit 140 may be a sound output device such as a speaker or headphones. The output unit 140 may also be constituted by a combination of the various devices described above.

### (Operation Unit)

The operation unit 150 accepts operations for the distributor D to input instructions or information to the distributor terminal 10. For example, the distributor D may include text, input by operating the operation unit 150, as part of the distribution content. The distributor D may also select a group G with which to hold bidirectional communication by operating the operation unit 150.

The operation unit 150 may also accept instructions on operations to be performed by the distribution server 30. The operation unit 150 may, for example, accept an instruction to start a livestream. During a livestream, the operation unit 150 may accept an instruction to transition to a scene in which the distributor D and the users U can communicate bidirectionally. By the operation unit 150 accepting an instruction to transition to a scene in which bidirectional communication by the distributor D is possible, the livestream can be provided while distinguishing between scenes in which bidirectional communication is difficult, such as during a live music performance, and scenes in which bidirectional communication is possible.

### <2-2. Example of Functional Configuration of User Terminal 20>

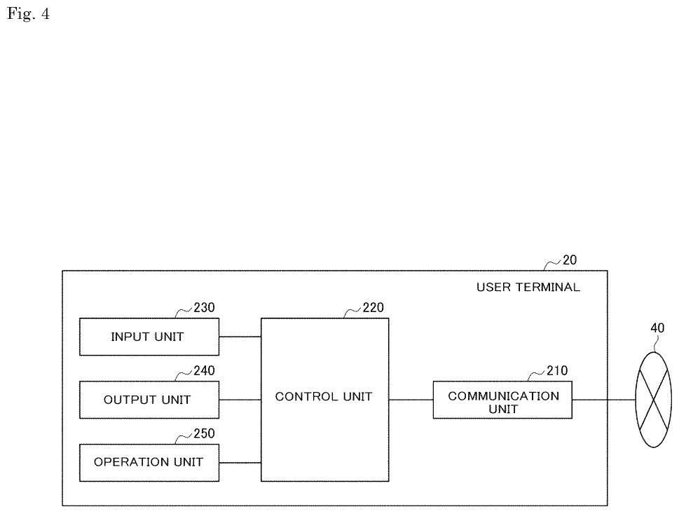

The configuration of the user terminal 20 used when the user U views the distribution content will be described next with reference to FIG. 4.

FIG. 4 is a block diagram illustrating an example of the configuration of the user terminal 20 according to the present embodiment. As illustrated in FIG. 4, the user terminal 20 includes a communication unit 210, a control unit 220, an input unit 230, an output unit 240, and an operation unit 250.

### (Communication Unit)

The communication unit 210 communicatively connects with the distribution server 30, and exchanges data therewith. For example, the communication unit 210 sends information on video, audio, or motion information obtained by the input unit 230, information such as text input to the operation unit 250, or information on the user object corresponding to the user U, to the distribution server 30. The communication unit 210 also receives information indicating video, audio, and text, information on the distributor object corresponding to the distributor D, and information on the virtual space from the distribution server 30. The information received from the distribution server 30 includes the distribution content provided by the distributor D. The information indicating the video, audio, and text received by the communication unit 210 from the distribution server 30 may also include information sent from other users U belonging to the same group G as the user U. The communication unit 210 may also receive, from the distribution server 30, information on the user objects corresponding to the other users U belonging to the same group G as the user U.

### (Control Unit)

The control unit 220 controls the overall operations of the user terminal 20. For example, the control unit 220 causes the communication unit 210 to send the information indicating video, audio, motion, or the like obtained by the input unit 230, the information such as text input to the operation unit 150, and the like. The control unit 220 also causes the output unit 240 to output information such as the video, audio, text, virtual space, and the like received from the distribution server 30 by the communication unit 210.

The control unit 220 generates the information on the user object based on the information indicating the video, motion, or the like input to the input unit 230. The user object may be, for example, a 3D or 2D photorealistic avatar, or may be a 3D or 2D CG character.

The control unit 220 also updates the information on the user object based on motion information, which is the information on motion input to the input unit 230. For example, if motion information on the hands of the user U is input to the input unit 230, the control unit 220 updates the information on the user object such that the hands of the user object move. If motion information on the face of the user U is input to the input unit 230, the control unit 220 may update the information on the user object such that the expression of the user object changes.

The control unit 220 may hold the information on the virtual space received from the distribution server 30. Furthermore, the control unit 220 may perform processing for generating information on a new virtual space by disposing the user object indicated by the information on the generated user object in the virtual space. Furthermore, the control unit 220 may perform processing for generating information on a new virtual space by disposing the user object and the distributor object indicated by the information on the user object and the information on the distributor object received by the communication unit 210 in the virtual space.

The control unit 220 may generate the information on the virtual space in which the distributor object and the other user objects are disposed from the viewpoint of the user object. The virtual space from the viewpoint of the user object may or may not include the user object.

### (Input Unit)

The input unit 230 obtains information indicating video, audio, text, motion, or the like detected by a sensor. For example, the input unit 230 may obtain information detected by a sensor such as a camera, a microphone, a keyboard, a mouse, a touchpad, an IMU, an IR sensor, a biosensor, or the like.

The input unit 230 obtains video of the user U captured by the camera, for example. The input unit 230 may also obtain the voice of the distributor D or sounds produced by the distributor D detected by a microphone. The input unit 230 may also obtain information on the user object in the virtual space, input through a keyboard by a user U and detected by the keyboard, e.g., location information or motion information on the user object, information on possessions of the user object, and the like. The input unit 230 may also obtain information on the motion of the user U (position, posture, arm and leg motion, head motion, and the like) detected by the IMU, or obtain information on motion of the face (motion of the eyes, eyebrows, mouth and the like) of the user U, motion of the gaze of the user U, and the like obtained by the camera. Note that the input unit 230 may obtain information input by a plurality of types of sensors.

### (Output Unit)

The output unit 240 has a function of outputting information such as the information received from the distribution server 30 by the communication unit 210. For example, the output unit 240 may be implemented as a 2D display, a 3D display, a projector, a stereo hologram presentation device, or the like. The output unit 240 may display the information on the virtual space on a 2D display as video. The output unit 240 may be a sound output device such as a speaker or headphones. The output unit 240 may also be constituted by a combination of the various devices described above.

### (Operation Unit)

The operation unit 250 accepts operations for the user U to input instructions or information to the user terminal 20. The instructions and information input to the operation unit 250 are sent to the distribution server 30 by the communication unit 210. For example, by operating the operation unit 250, the user U may use a chat function to send a response to the distribution content, using text, a stamp, or the like, in real time. Alternatively, by operating the operation unit 250, the user U may use what is known as a “tipping system” in which the user U sends an item, which the distributor D can redeem for money, for the distribution content.

The user U may also specify the group G to which that user U belongs by operating the operation unit 250. The user U may specify the group G to which that user U belongs by, for example, inputting a group ID in the operation unit 250.

The user U may also input profile information of that user U by operating the operation unit 250. The profile information includes, for example, information such as the gender, age, musical tastes, and the like of the user U. Additionally, by operating the operation unit 250, the user U may select a genre for a livestream to be viewed, from among genres displayed in the output unit 240.

### <2-3. Example of Functional Configuration of Distribution Server 30>

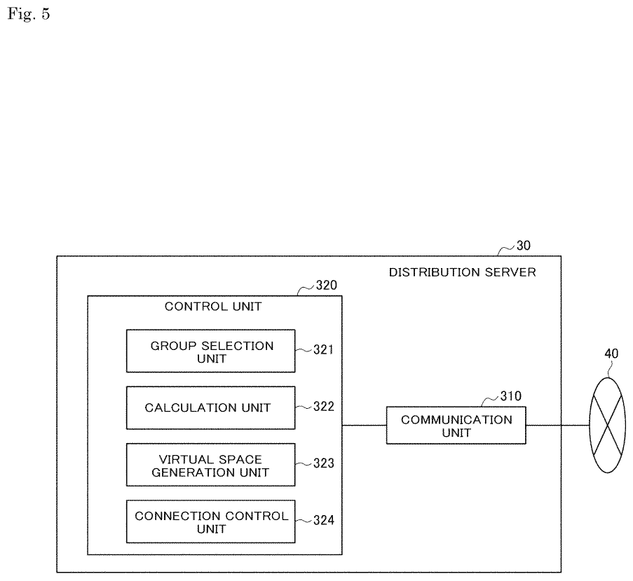

The configuration of the distribution server 30 that sends the distribution content provided by the distributor D will be described next with reference to FIG. 5.

FIG. 5 is a block diagram illustrating an example of the configuration of the distribution server 30 according to the present embodiment. As illustrated in FIG. 5, the distribution server 30 includes a communication unit 310 and a control unit 320.

### (Communication Unit)

The communication unit 310 communicates with the distributor terminal 10 and the user terminals 20 over the network 40. The communication unit 310 communicates with the distributor terminal 10 and the user terminals 20 under the control of a connection control unit 324. The communication unit 310 sends the distribution content provided by the distributor D to the plurality of user terminals 20, for example.

### (Control Unit)

The control unit 320 controls the overall operations of the distribution server 30. The control unit 320 controls the operations of the distribution server 30 in response to instructions received from the distributor terminal 10 by the communication unit 310, for example. In particular, in the present embodiment, the control unit 320 functions as a group selection unit 321, a calculation unit 322, a virtual space generation unit 323, and the connection control unit 324.

### (Group Selection Unit)

The group selection unit 321 selects one, or two or more, groups G from the plurality of groups G, to each of which two or more users U belong. For example, the group selection unit 321 selects a first group, which is a group G having the right to communicate bidirectionally with the distributor D, from among the plurality of groups G. The connection control unit 324, which will be described later, controls a connection to enable the bidirectional communication between the users U belonging to the first group and the distributor D. The group selection unit 321 may, for example, select the group G based on a condition pertaining to an excitement level or a contribution level calculated by the calculation unit 322, which will be described later. The group selection unit 321 may select the group G based on an instruction from the distributor terminal 10, received by the communication unit 310.

The group selection unit 321 may also newly reselect the group G based on a predetermined condition. The group selection unit 321 may, for example, newly select the group G based on a condition pertaining to an excitement level or a contribution level calculated by the calculation unit 322, which will be described later. Specifically, the group selection unit 321 may newly select the group G having the highest excitement level or contribution level. Alternatively, the group selection unit 321 may newly reselect the group G based on whether a group has been selected by the distributor D. In this case, the group selection unit 321 may newly reselect the group G based on an instruction from the distributor terminal 10, received by the communication unit 310.

The group selection unit 321 may also newly reselect the group G based on the length of time that has passed since a given group G was selected. The group selection unit 321 may, for example, sequentially reselect the group G such that the length of time from when one group G is selected to when a new group Gis selected is equal for all the groups G. Additionally, the group selection unit 321 may sequentially reselect the group G such that the length of time for which the group G is selected is longer for groups G having a higher excitement level or contribution level.

The total number of groups G selected by the group selection unit 321 may be a predetermined number, or may be changed dynamically based on load conditions of the communication performed by the communication unit 310. Additionally, the number of groups G selected by the group selection unit 321 may be determined based on a result of calculation performed by the calculation unit 322, which will be described later. For example, the group selection unit 321 may determine the number of groups G selected based on an average of the excitement levels or the contribution levels of the groups G.

Note that the group selection unit 321 has a function for determining the users U belonging to each of the groups G. The group selection unit 321 may determine the users U belonging to each of the groups G at random. Based on the profile information of each of the users U, sent by the user terminal 20, the group selection unit 321 may determine that users U having matching profile information are to belong to the same group G. Additionally, the group selection unit 321 may determine the users U belonging to a group G in accordance with specifications of the group G to which the users U are to belong, sent from the user terminal 20.

### (Calculation Unit)

The calculation unit 322 calculates the excitement level or contribution level of each of the users U belonging to the same group G based on communication among the users U belonging to the same group G. For example, the calculation unit 322 calculates the excitement level of the user U based on video, audio, text, or motion input by the user U. Specifically, the calculation unit 322 may calculate the excitement level of the user U such that the excitement level of the user U becomes higher as the length of time audio is input by the user U increases. Additionally, the calculation unit 322 may calculate the excitement level of the user U such that the excitement level of the user U becomes higher as the amount of text input by the user U increases.

The calculation unit 322 may calculate the contribution level of the user U based on the extent to which the video, audio, text, or motion input by the user U conforms to a condition specified by the distributor D. Specifically, the calculation unit 322 may calculate the contribution level of the user U based on whether a keyword specified by the distributor D has been input by the user U. The calculation unit 322 may also calculate the contribution level of the user U such that the contribution level of the user U increases with the value of items in the tipping system used by the user U.

Additionally, the calculation unit 322 may calculate the excitement level or contribution level of each of the plurality of groups G based on communication among the users U belonging to the same group G. For example, the calculation unit 322 may calculate the excitement level or the contribution level of a group G by adding together the excitement levels or contribution levels of the users U belonging to that group G.

The excitement levels and contribution levels of the users U or the groups G, calculated by the calculation unit 322, may be sent to the user terminals 20 by the communication unit 310 and displayed in the user terminals 20. For example, a ranking chart of the excitement levels of the groups G may be displayed in the user terminals 20. When the group selection unit 321 newly selects a group G that can communicate bidirectionally with the distributor D based on a condition pertaining to the excitement level, the user U can determine how to behave by confirming the ranking chart. In other words, displaying the excitement levels or contribution levels calculated by the calculation unit 322 in the user terminals 20 makes it possible to increase the sense of immersion of the livestream.

### (Virtual Space Generation Unit)

The virtual space generation unit 323 generates a virtual space in which the distributor object and the user objects are disposed. The virtual space generation unit 323 may determine the location, in the virtual space, where the objects of the distributor D or the users U are to be disposed. The virtual space generation unit 323 may dispose the objects corresponding to the distributor D or the users U in the virtual space. The virtual space generation unit 323 may generate the distributor object and the user objects based on information indicating video, motion, or the like received from the distributor terminal 10 or the user terminals 20.

### (Connection Control Unit)

The connection control unit 324 controls communication by the communication unit 310. The connection control unit 324 controls connections to enable bidirectional communication between the users U belonging to the group G selected by the group selection unit 321 and the distributor D. For example, the connection control unit 324 may control the communication unit 310 to send the information on the user objects, sent from the users U belonging to the groups G selected by the group selection unit 321, to the distributor terminal 10 used by the distributor D. The connection control unit 324 may also send information such as video, audio, text, or the like, sent from the users U belonging to the group G selected by the group selection unit 321, to the distributor terminal 10.

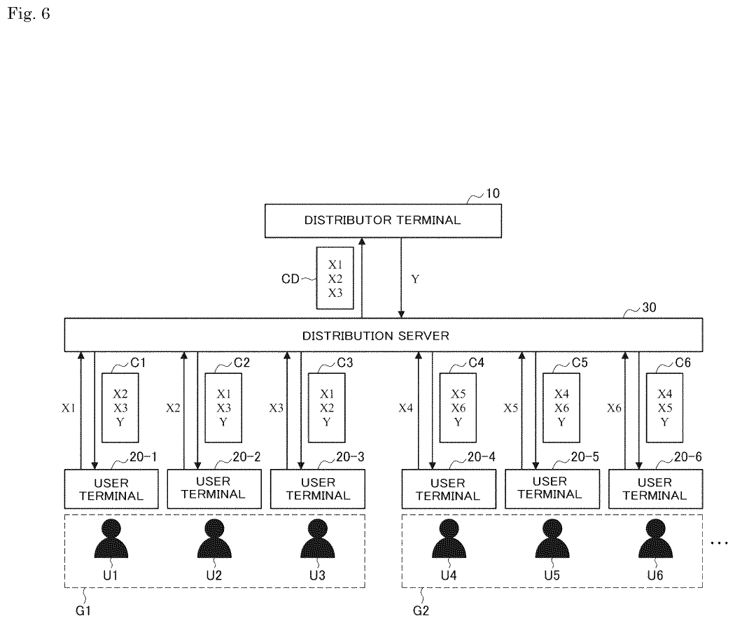

FIG. 6 is an explanatory diagram illustrating a specific example of connection control by the connection control unit 324. The example illustrated in FIG. 6 assumes that the group G1 is selected by the group selection unit 321 as a group G that can communicate bidirectionally with the distributor D.

As illustrated in FIG. 6, the distributor terminal 10 sends distributor data Y to the distribution server 30. The user terminals 20 send user data X to the distribution server 30. The distributor data Y and the user data X include information on the distributor object and information on the user objects, respectively. FIG. 6 illustrates what data is included in information CD sent to the distributor terminal 10 and information (distribution content) C sent to the user terminals 20. For example, distribution content C1 sent to the user terminal 20-1 includes user data X2 and X3, and the distributor data Y.

The connection control unit 324 controls connections to enable bidirectional communication between the users U belonging to the group G1 selected by the group selection unit 321 and the distributor D. Here, the connection control unit 324 controls the communication such that information CD sent to the distributor terminal 10, which includes user data X1 to X3, is sent to the distributor terminal 10. This makes it possible for the users U belonging to the group G1 to communicate bidirectionally with the distributor D. Note that the distributor data Y and the user data X may include audio information, and including the audio information in the information CD sent to the distributor terminal 10 and the information C sent to the user U enables bidirectional communication that provides a higher experience value.

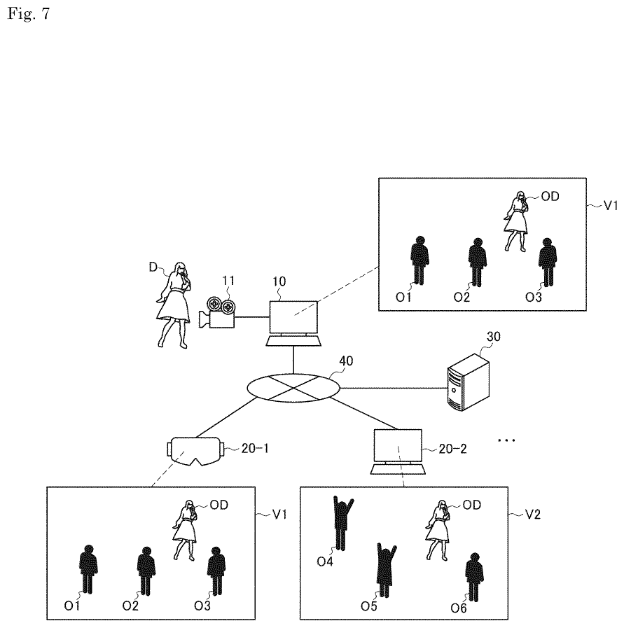

FIG. 7 is an explanatory diagram illustrating screen images in each terminal in the specific example illustrated in FIG. 6. Video of a virtual space V in which a distributor object OD and user objects O are disposed is output to the screens of the distributor terminal 10 and the user terminals 20. Video of a virtual space V1 generated by the control unit 220 of the user terminal 20-1 is output to the screen of the user terminal 20-1 illustrated in FIG. 7 based on the user data X2 and X3 included in the distribution content C1, the distributor data Y, and the user data X1 input to that terminal itself. Additionally, video of the virtual space V1 generated by the control unit 120 of the distributor terminal 10 is output to the screen of the distributor terminal 10 based on the user data X1 to X3 and the distributor data Y, in the same manner as for the user terminal 20-1.

Although an example of similar video being output to the screens of the distributor terminal 10 and the user terminal 20-1 has been described here, any video indicating the same virtual space V1 may be output to the screens of the distributor terminal 10 and the user terminal 20-1, and other video taken from a different viewpoint may be displayed.

The connection control unit 324 will be described with reference to FIG. 6. The connection control unit 324 performs control such that distribution content C4 to C6, which includes user data X and distributor data Y sent from other users belonging to the group G2, is sent to users U4 to U6, respectively. The users U4 to U6 are therefore capable of communicating with each other. On the other hand, the information CD sent to the distributor terminal 10 does not include the user data X4 to X6, the users U belonging to the group G2 cannot communicate bidirectionally with the distributor D.

Similar to the descriptions given above, video of a virtual space V2 generated by the control unit 220 of the user terminal 20-4 is output to the screen of the user terminal 20-4 illustrated in FIG. 7 based on the user data X5 and X6 included in the distribution content C4, the distributor data Y, and the user data X4 input to that terminal itself.

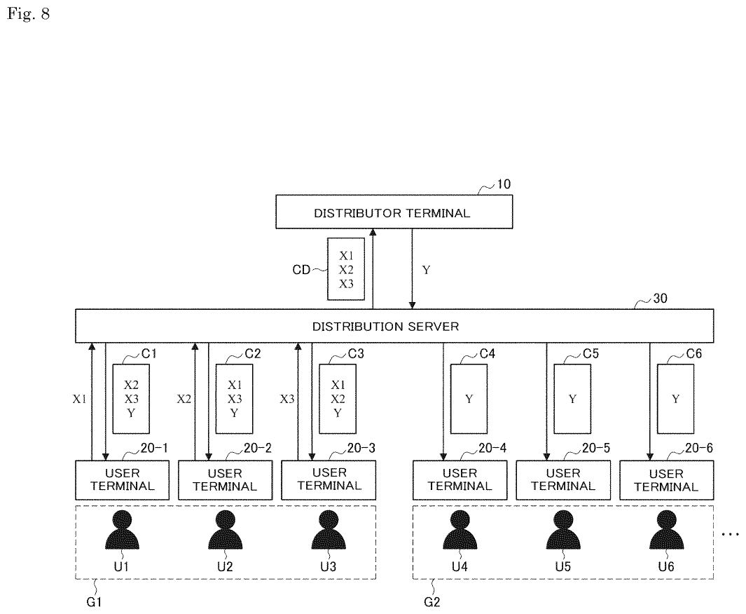

Another specific example of connection control by the connection control unit 324 will now be described with reference to FIG. 8. FIG. 8 is an explanatory diagram illustrating another specific example of connection control by the connection control unit 324. In the example illustrated in FIG. 8, the communication performed by the distributor terminal 10 and the user terminals 20-1 to 20-3, which is controlled by the connection control unit 324, is similar to that in the specific example described with reference to FIG. 6. On the other hand, the connection control unit 324 performs control such that the user data X is not received from the user terminals 20 belonging to the group G2, which is not selected by the group selection unit 321. On the other hand, the connection control unit 324 performs control such that distribution content C4 to C6, which includes only distributor data Y, is sent to the users U4 to U6, respectively. Having the connection control unit 324 perform the foregoing connection control makes it possible to suppress the load of the communication performed by the communication unit 310 compared to that in the specific example described with reference to FIG. 6.

Although an example in which one distributor D performs one livestream has been described thus far, the number of distributors D may be two or more, and a plurality of distributors D may each perform a separate livestream. In this case, the connection control unit 324 may determine the livestream, among the plurality of livestreams, for which the distribution content is to be sent to the user terminal 20 based on a genre selected by the user U, received from the user terminal 20 by the communication unit 310. In this case, the connection control unit 324 controls the connection of the communication unit 310 based on the determination. Additionally, if no livestream is being performed for the genre selected by the user U, the connection control unit 324 may control the connection such that users U belonging to the same group G can communicate with each other until the livestream starts.

### 3. EXAMPLE OF OPERATION PROCESSING ACCORDING TO EMBODIMENT

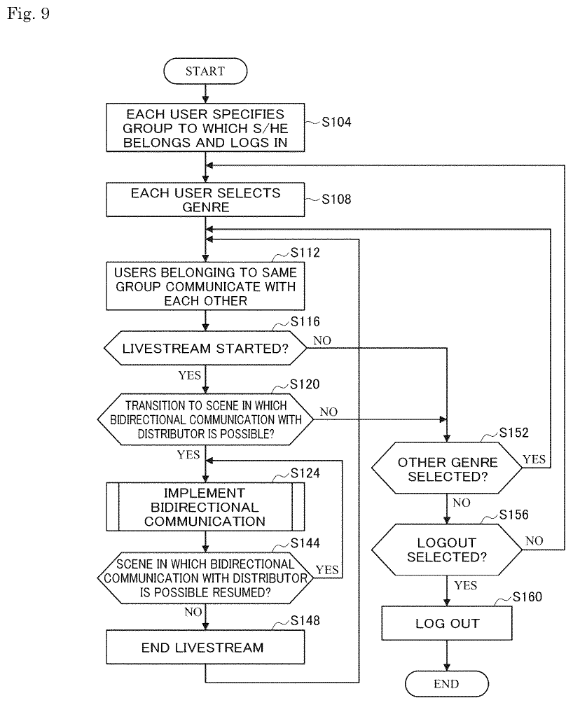

An example of operations by the distribution server 30 according to the present embodiment will be described next. FIG. 9 is a flowchart illustrating an example of operations by the distribution server 30 according to the present embodiment.

First, by operating the corresponding user terminal 20, each user U specifies the group G to which he or she belongs, and logs in to a distribution system for viewing the distribution content provided by the distributor D (S104). The group selection unit 321 of the distribution server 30 determines the users U belonging to each of the groups G according to the specifications of the groups G to which the users U belong, received by the communication unit 310. Each user U then selects a genre of livestream to view by operating the corresponding user terminal 20 (S108).

The connection control unit 324 controls the communication by the communication unit 310 such that the users U belonging to the same group G can communicate with each other. For example, the connection control unit 324 controls the communication by the communication unit 310 such that the information on the user objects, and the information such as video, audio, text, and the like, received from the user terminals 20 used by the other users U belonging to the group G, are sent to the user terminals 20 used by the users U belonging to the same group G. The output unit 240 of the user terminal 20 outputs a video of the virtual space including the user objects corresponding to the other users U belonging to that group G. The user U communicates with other users U belonging to the same group G (S112).

When an instruction from the distributor terminal 10 is received by the communication unit 310 and a livestream is started by the distributor D for the genre selected by the user U (S116/Yes), a unidirectional distribution from the distributor D is provided to the user U. Specifically, the output unit 240 of each of the user terminals used by the users belonging to each group G outputs a video of the virtual space including the distributor object received from the distribution server 30 by the communication unit 210. The communication unit 310 of the distribution server 30 also sends information such as video, audio, text, and the like received from the distributor terminal 10 to each user terminal 20.

Next, when the communication unit 310 receives an instruction from the distributor terminal 10 to transition to a scene in which communication is possible (S120/Yes), the control unit 320 controls the implementation of bidirectional communication between the users U and the distributor D (S124).

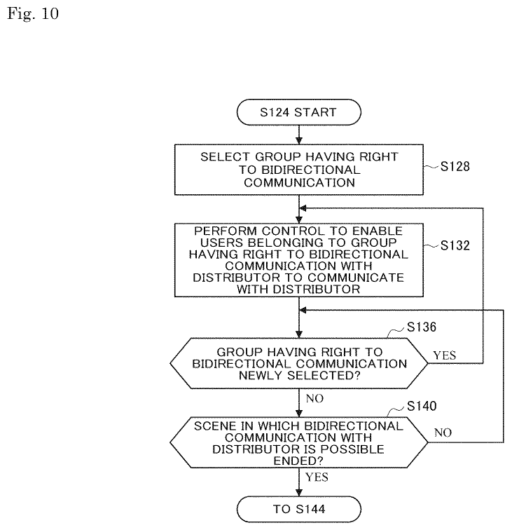

The operations performed in S124 will be described in detail with reference to FIG. 10. FIG. 10 is a flowchart illustrating an example of operations for implementing bidirectional communication controlled by the distribution server 30 according to the present embodiment.

When the communication unit 310 receives an instruction from the distributor terminal 10 to start implementing bidirectional communication between the users U and the distributor D, the group selection unit 321 selects the group G that is to perform bidirectional communication with the distributor D (S128). The connection control unit 324 controls the communication by the communication unit 310 so as to enable communication between the distributor D and the users U belonging to the group G having the right to communicate bidirectionally with the distributor D (S132). For example, the connection control unit 324 performs control to send the information on the user objects, sent from the users U belonging to the groups G selected by the group selection unit 321, to the distributor terminal 10 used by the distributor D. The connection control unit 324 also sends information such as video, audio, text, and the like, sent from the users U belonging to the group G selected by the group selection unit 321, to the distributor terminal 10.

When a group G having the right to bidirectional communication is newly selected by the group selection unit 321 (S136/Yes), the control unit 320 returns the sequence to S132, and the connection control unit 324 performs control such that the users U belonging to the newly-selected group G and the distributor D are capable of communicating.

If a group G having the right to bidirectional communication has not been newly selected by the group selection unit 321 (S136/No), the sequence moves to S140. If the scene in which bidirectional communication is possible has been terminated in response to an instruction from the distributor terminal 10, received by the communication unit 310 (S140/Yes), the sequence moves to S144 of FIG. 9. If the scene in which bidirectional communication with the distributor D is possible is not terminated (S140/No), the control unit 320 returns the sequence to S136. The operations from S136 to S140 are repeated until the distribution server 30 receives an instruction from the distributor terminal 10 through the communication unit 310 and the scene in which bidirectional communication with the distributor D is possible ends.

The descriptions of operations from S144 will be continued with reference to FIG. 9. When an instruction to resume the scene in which bidirectional communication is possible is received from the distributor terminal 10 by the communication unit 310, the scene in which bidirectional communication with the distributor D is possible is resumed (S144/Yes). In this case, the control unit 320 again performs the control of S124 for implementing bidirectional communication.

If, when the scene in which bidirectional communication with the distributor D is possible is not to be resumed (S144/No), and an instruction is received from the distributor terminal 10 by the communication unit 310, the control unit 320 controls the livestream to end. The control unit 320 returns the sequence to S112 after the livestream ends.

If a livestream is not started (S116/No), and if not transitioning to a scene in which bidirectional communication with the distributor D is possible (S120/No), the control unit 320 determines whether the communication unit 310 has newly received a selection of a preferred genre of each of the users U from the corresponding user terminals 20. If a preferred genre has been newly selected by the user U (S152/Yes), the control unit 320 returns the sequence to S112. The control unit 320 also returns the sequence to S112 if a preferred genre has not been newly selected by the user U (S152/No) and the communication unit 310 has not received a selection from the user terminal 20 to log out from the distribution system (S156/No). However, if the communication unit 310 has received a selection from the user terminal 20 to log out from the distribution system (S156/Yes), the control unit 320 logs the user U using that user terminal 20 out from the distribution system (S160).

### 4. EXAMPLE OF ACTIONS AND EFFECTS OF EMBODIMENT

A variety of effects can be achieved by the distribution server 30 according to the present disclosure as described thus far. The distribution server 30 according to the present disclosure makes it possible for users U belonging to the same group G to communicate with each other. As a comparative example, consider a configuration in which information such as text, audio, or the like, received from a user U viewing a livestream, is sent to all users U. However, when many users U view a livestream, if the user U receives all the other information sent from the other users U, that user U may find the information sent from the other users U to be a nuisance. However, with the distribution server 30 according to the present disclosure, the user terminals 20 only receive the information sent from a limited number of users U, an enjoyable livestream can be provided to the user U.

In particular, when information on a group G to which the user U using a user terminal 20 is received from that user terminal 20, a plurality of users U can determine amongst themselves that they belong to the same group G. In this case, the user U can receive information sent from other users U that the stated user U knows, which makes it possible to increase the value of the experience for the user U.

Additionally, with the distribution server 30 according to the present disclosure, the communication unit 310 sends information on the user objects sent from the users U belonging to the group G to the distributor terminal 10 and the user terminals 20. As a comparative example, consider a configuration in which information on user objects corresponding to all users U viewing a livestream is sent to the distributor terminal 10 and the user terminals 20. However, with the distribution server 30 according to the present disclosure, the load for rendering the virtual space by the distributor terminals 10 and the user terminals 20 can be reduced compared to the comparative example. Additionally, with the distribution server 30 according to the present disclosure, the communication load between the distributor terminal 10 and the user terminals 20, and the distribution server 30, can be reduced.

Additionally, with the distribution server 30 according to the present disclosure, the group selection unit 321 newly reselects a group G having a right to bidirectional communication with the distributor D based on a predetermined condition. According to this configuration, more users U can communicate bidirectionally with the distributor D through the limited number of channels on which bidirectional communication is possible. For example, even if the distribution content is streamed live to tens of thousands of people, the value of the experience for more users U can be increased by moving among the groups G that have the right to bidirectional communication.

### 5. VARIATIONS ON EMBODIMENT

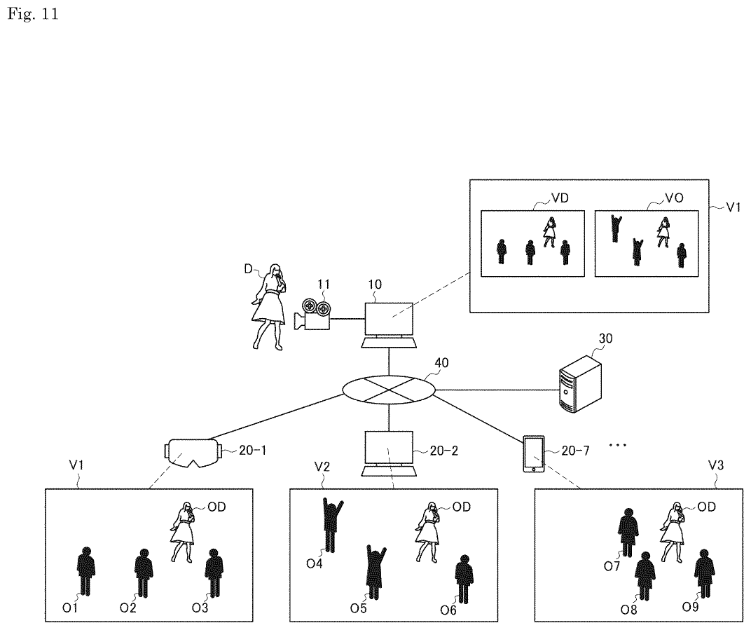

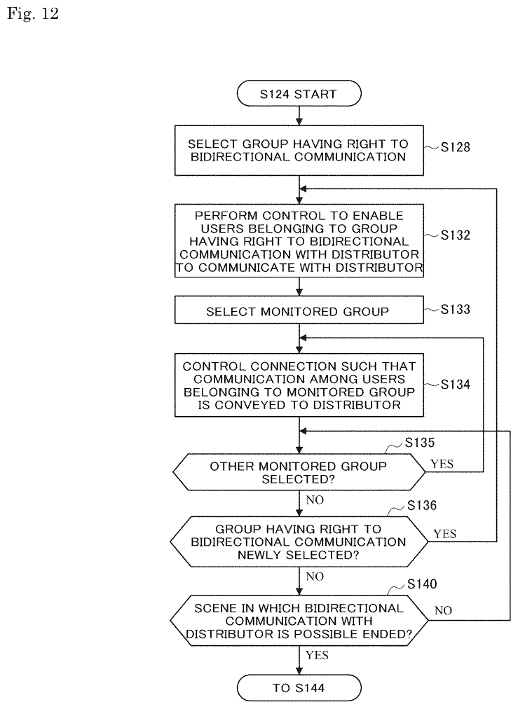

An example of the operations by the distribution server 30 according to the present embodiment has been described thus far. However, the technique according to the present disclosure is not limited to the foregoing embodiment. Variations on the distribution server 30 according to the present disclosure will be described hereinafter with reference to FIGS. 11 and 12.

### <5-1. First Variation>

A first variation according to the present disclosure will be described first. Of the constituent elements in the distribution server 30 according to the first variation, additional functions of the group selection unit 321 and the connection control unit 324 will be described first.

### (Group Selection Unit)

The group selection unit 321 further has a function for selecting a second group, which is one, or two or more groups, from among a plurality of groups G not selected as groups G having the right to bidirectional communication. The connection control unit 324, which will be described later, controls the connection such that communication between the users U belonging to a group G to be monitored, which is the second group, is conveyed to the distributor D.

The group selection unit 321 may also newly reselect the group G to be monitored, based on a predetermined condition. For example, the group selection unit 321 may newly reselect the group G to be monitored based on an instruction from the distributor terminal 10, received by the communication unit 310.

The group selection unit 321 may also newly reselect the group G to be monitored based on the length of time that has passed since a given group G to be monitored was selected. The group selection unit 321 may, for example, sequentially reselect the group G to be monitored such that the length of time from when one group G to be monitored is selected to when a new group G to be monitored is selected is equal for all the groups G to be monitored.

### (Connection Control Unit)

The connection control unit 324 further has a function for controlling the connection such that communication between the users U belonging to a group G to be monitored is conveyed to the distributor D. For example, the connection control unit 324 may control the communication unit 310 to send the information on the user objects corresponding to the users U belonging to the group G to be monitored, selected by the group selection unit 321, to the distributor terminal 10 used by the distributor D for monitoring. In this case, both the video of the virtual space including the user objects belonging to the group G that can communicate bidirectionally with the distributor D, and the video of a virtual space for monitoring that includes the user objects belonging to the group G to be monitored, are displayed on the screen of the distributor terminal 10. The connection control unit 324 may also send information such as video, audio, text, or the like, sent from the users U belonging to the group G to be monitored, selected by the group selection unit 321, to the distributor terminal 10.

FIG. 11 is an explanatory diagram illustrating an example of screen images in each terminal in the first variation of the present disclosure. In the example illustrated in FIG. 11, it is assumed that the user U using the user terminal 20-1 belongs to the group G1, the user U using the user terminal 20-3 belongs to the group G2, and the user U using the user terminal 20-4 belongs to a group G3. Additionally, it is assumed that the group G1 is selected by the group selection unit 321 as a group G that can communicate bidirectionally with the distributor D. Furthermore, it is assumed that the group G2 has been selected as the group G to be monitored by the group selection unit 321.

Video of a virtual space VD, in which the distributor object OD and the user objects O corresponding to the users U belonging to the group G1 are disposed, is output to the screen of the distributor terminal 10. Furthermore, video of a virtual space VO for monitoring, in which the distributor object OD and the user objects O corresponding to the users U belonging to the group G2 are disposed, is output to the screen of the distributor terminal 10. Here, a conventional unidirectional distribution is provided to the users U belonging to the group G2 and the group G3.

The distributor D communicates with the users U belonging to the group G1 while watching the video of the virtual space VD. Meanwhile, the distributor D confirms the video of the virtual space VO for monitoring, and monitors the communication among the users U belonging to the group G2, which is the group G to be monitored. The distributor D can use the video of the virtual space including the user objects belonging to the group G to be monitored as a basis for determining the selection of the group G that can communicate bidirectionally with the distributor D. Furthermore, by having the group selection unit 321 newly reselect the group G to be monitored, the video of the virtual space VO for monitoring is switched to the video of the virtual space including the user objects belonging to another group G. By confirming the video of the virtual space including the user objects belonging to a plurality of groups G, the distributor D can efficiently select the group G capable of communicating bidirectionally with the distributor D.

An example of operations by the distribution server 30 according to the first variation of the present disclosure will be described next. FIG. 12 is a flowchart illustrating an example of operations for implementing bidirectional communication controlled by the distribution server 30 according to the first variation of the present disclosure.

The operations for selecting the group G having a right to bidirectional communication, performed in S128, and the operations for controlling the implementation of the bidirectional communication, performed in S132, have already been described with reference to FIG. 10, and will therefore not be described here. When the group G to be monitored (a monitored group) is selected by the group selection unit 321 (S133), the connection control unit 324 controls the connection such that communication among the users U belonging to the group G to be monitored is conveyed to the distributor D (S134). When a group G to be monitored is newly selected by the group selection unit 321 (S135/Yes), the control unit 320 returns the sequence to S134. The connection control unit 324 controls the connection such that communication between the users U belonging to a group G to be monitored, which has been newly selected, is conveyed to the distributor D.

If a group G to be monitored has not been newly selected by the group selection unit 321 (S135/No), the control unit 320 determines whether a group G having a right to bidirectional communication has been newly selected (S136). Here, the distributor D can judge whether a group G having a right to bidirectional communication has been newly determined based on the details of the communication among the users U belonging to the group G to be monitored.

When the group selection unit 321 newly selects a group G having a right to bidirectional communication (S136/Yes), the control unit 320 returns the sequence to S132. When the group selection unit 321 newly selects a group G having a right to bidirectional communication (S136/No), the sequence moves to S140. If the scene in which bidirectional communication is possible has been terminated in response to an instruction from the distributor terminal 10, received by the communication unit 310 (S140/Yes), the sequence moves to S144 of FIG. 9. If the scene in which bidirectional communication with the distributor D is possible is not terminated (S140/No), the control unit 320 returns the sequence to S135. The operations from S132 to S140 are repeated until the distribution server 30 receives an instruction from the distributor terminal 10 through the communication unit 310 and the scene in which bidirectional communication with the distributor D is possible ends.

### <5-2. Second Variation>

The foregoing has described an example of operations by the distribution server 30 according to the first variation of the present disclosure, with reference to FIG. 12. A second variation of the present disclosure will be described next. In the second variation of the present disclosure, when a given group G is selected by the group selection unit 321, the virtual space generation unit 323 generates a specific virtual space in which only the distributor object and the user objects corresponding to the users U belonging to that group G are disposed. The specific virtual space may be a space tailored to a scenario of the distribution content. The scenario of the distribution content is, for example, a talk session, a sightseeing tour, a drive, a boat ride, a fireworks festival, an exhibition tour, an art museum tour, or the like. For example, when the scenario of the distribution content is a drive, the specific virtual space is a vehicle interior.

Additionally, the virtual space generation unit 323 may determine a location, in the virtual space, at which each of the user objects representing the users U belonging to the group G selected by the group selection unit 321 are located, from among a plurality of types of locations having different experience values pertaining to communication with the distributor D. For example, when the virtual space generated by the virtual space generation unit 323 is a vehicle interior as mentioned above, the virtual space generation unit 323 may determine the distribution object as being located in the driver's seat, and may determine the user objects corresponding to the plurality of users U belonging to the group G as being located in the passenger seat or the rear seats. Here, the user terminal 20 may generate the information on the virtual space, and perform processing, according to the location of the corresponding user object determined by the virtual space generation unit 323.

Note that the virtual space generation unit 323 may determine the location of each user object in the virtual space based on the excitement level or the contribution level of the corresponding user U, calculated by the calculation unit 322. The virtual space generation unit 323 may change the location of each user object in the virtual space as time passes. The virtual space generation unit 323 may determine the location of each user object in the virtual space based on instructions from the distributor terminal 10, received by the communication unit 310.

### <5-3. Third Variation>

The foregoing has described the second variation of the present disclosure. A third variation of the present disclosure will be described next. In the third variation of the present disclosure, the connection control unit 324 determines a method by which each user U belonging to the group G selected by the group selection unit 321 communicates with the distributor D. The connection control unit 324 may determine the method of communication with the distributor D from among a plurality of types of methods having different experience values with respect to the communication with the distributor D.

For example, the connection control unit 324 may control a connection for audio information such that only a given user U can converse with the distributor D. Additionally, when audio information sent from the distributor D is sent to the users U, the connection control unit 324 may determine the volume and clarity of that audio for each of the users U. Additionally, the connection control unit 324 may determine the method through which each of the users U communicates with the distributor D based on the excitement level or the contribution level of each of the users U, calculated by the calculation unit 322.

### <5-4. Other Variations>

The foregoing has described the third variation the present disclosure. Other variations of the present disclosure will be described next. For example, although the foregoing embodiment describes an example in which one distributor D is present, a bidirectional distribution system in which two or more distributors D can participate may be configured, within a permissible range of the bidirectional channel resources. In this case, the group selection unit 321 may select groups G having different rights for bidirectional communication for each of the distributors D. The group selection unit 321 may also select a single group G having a right to bidirectional communication. In this case, the connection control unit 324 may control the connections such that all the distributors D can communicate with the users U belonging to the group G having the right to bidirectional communication.

Additionally, the foregoing embodiment describes an example in which, in conventional unidirectional distribution, the video of the virtual space including the user objects belonging to the group G, to which the users U using the user terminals 20 to which the distribution content is sent belong, is output to the screens of the user terminals 20. However, the video output to the screens of the user terminals 20 is not limited to this example. For example, in addition to the video mentioned above, video of a virtual space including the user objects belonging to a group G implementing bidirectional communication may be displayed in the screens of the user terminals 20 used by the users U receiving the unidirectional distribution. Additionally, information such as video, audio, text, and the like sent from the group G implementing bidirectional communication may be sent to the user terminals 20 used by the users U receiving the unidirectional distribution.

Additionally, although the foregoing embodiment describes an example in which the distribution content is sent from the distribution server 30 to the user terminals 20, the distribution content may be sent from the distribution server 30 to the user terminals 20 via the cloud. The distribution server 30 may send the distribution content to a plurality of cloud devices. In this case, the distribution content is sent from one cloud device, among the plurality of cloud devices, to the user terminals 20, based on the areas in which those user terminals 20 are present.

Additionally, although the foregoing embodiment describes an example in which the calculation unit 322 calculates the excitement level and the contribution level, the calculation unit 322 may calculate another indicator. For example, if the distribution content is distance learning content, the calculation unit 322 may calculate a concentration level of the user U. Specifically, the communication unit 310 receives information indicating how the user U is moving his or her fingertips as the motion information of the user U from the user terminal 20. The calculation unit 322 may calculate the concentration level of the user U based on that motion information. In this case, implementing bidirectional communication makes it possible for the distributor D, who is a teacher, to urge the user U to concentrate.

Additionally, if the distribution content is distance learning content or remote support content, the calculation unit 322 may calculate a progress level of the user U. Specifically, if the distribution content is distance learning content, the communication unit 310 receives, from the user terminal 20, an answer to a problem entered by the user U, who is a student. The calculation unit 322 may calculate the progress level based on a correct answer rate or a problem progress status for the user U. In this case, implementing bidirectional communication makes it possible for the distributor D, who is a teacher, to deliver class content suited to the user U.

Additionally, if the distribution content is remote support content, the communication unit 310 receives, from the user terminal 20, the total number of components assembled by the user U, who is a worker. The calculation unit 322 may then calculate a progress level based on the degree to which the user U has met a component assembly quota. In this case, implementing bidirectional communication makes it possible for the distributor D, who is a factory leader or manager, to urge the user U to improve his or her work.

Additionally, if the distribution content is a remote training lesson such as for golf, bodybuilding, yoga, a musical instrument, singing, or the like, the calculation unit 322 may calculate an execution score of the user U. Specifically, the communication unit 310 receives the motion information of the user U, who is a student, from the user terminal 20, and calculates the execution score of the user U based on the consistency between (i) the motion indicated by the motion information and (ii) a correct motion sent by the distributor terminal 10 used by the distributor D, who is a teacher. In this case, implementing bidirectional communication makes it possible for the distributor D, who is a teacher, to urge the user U to improve his or her execution.

### 6. HARDWARE CONFIGURATION

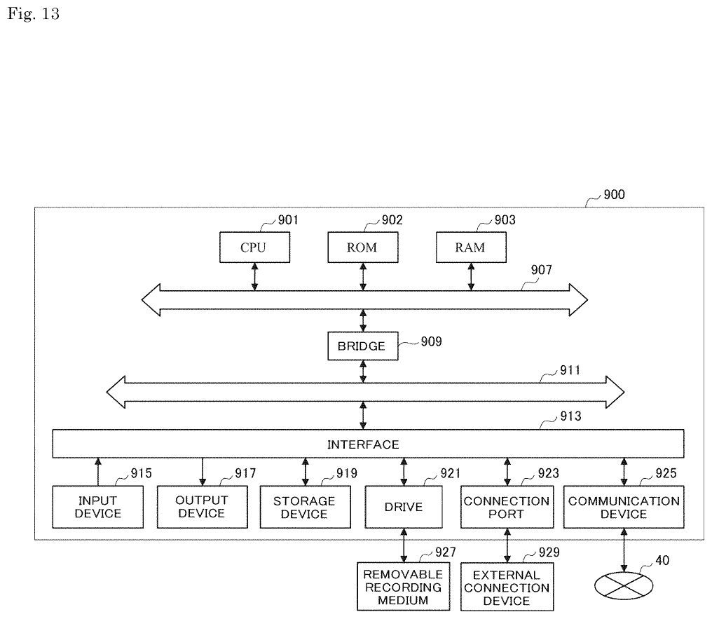

The foregoing has described an embodiment and variations according to the present disclosure. An example of the hardware configuration of the distribution server 30 according to the embodiment of the present disclosure will be described next with reference to FIG. 13.

The processing by the distributor terminal 10, the user terminal 20, and the distribution server 30 described above may be implemented by one or more information processing devices. FIG. 13 is a block diagram illustrating an example of the hardware configuration of an information processing device 900 which realizes the distributor terminal 10, the user terminal 20, and the distribution server 30 according to the embodiment of the present disclosure. Note that the information processing device 900 does not necessarily have to have all the parts of the hardware configuration illustrated in FIG. 13. Additionally, some parts of the hardware configuration illustrated in FIG. 13 may be absent from the distributor terminal 10, the user terminal 20, or the distribution server 30.

As illustrated in FIG. 13, the information processing device 900 includes a CPU 901, a Read Only Memory (ROM) 903, and a RAM 905. The information processing device 900 may further include a host bus 907, a bridge 909, an external bus 911, an interface 913, an input device 915, an output device 917, a storage device 919, a drive 921, a connection port 923, and a communication device 925. The information processing device 900 may have processing circuitry, called a Graphics Processing Unit (GPU), a Digital Signal Processor (DSP), an Application Specific Integrated Circuit (ASIC), or the like, instead of or in addition to the CPU 901.

The CPU 901 functions as an arithmetic processing device and a control device, and controls some or all of the operations in the information processing device 900 according to various programs recorded in the ROM 903, the RAM 905, the storage device 919, or a removable recording medium 927. The ROM 903 stores programs used by the CPU 901, computation parameters, and the like. The RAM 905 temporarily stores programs used for execution by the CPU 901, parameters that change as appropriate in the execution, and the like. The CPU 901, the ROM 903, and the RAM 905 are connected to each other by the host bus 907 constituted by an internal bus, such as a CPU bus. The host bus 907 is further connected to the external bus 911, such as a Peripheral Component Interconnect/Interface (PCI) bus, by the bridge 909.

The input device 915 is, for example, a device operated by the user, such as a button. The input device 915 may include a mouse, a keyboard, a touch panel, switches, levers, and the like. Further, the input device 915 may also include a microphone that detects a voice of the user. The input device 915 may be, for example, a remote control device using infrared rays or other radio waves, or may be an external connection device 929 such as a mobile phone corresponding to an operation of the information processing device 900. The input device 915 includes an input control circuit that generates an input signal on the basis of information input by the user and outputs the input signal to the CPU 901. The user inputs various pieces of data to the information processing device 900 or instructs processing operations by operating the input device 915.

The input device 915 may also include an image capturing device and a sensor. The image capturing device is a device that captures an image of a real space using, for example, an image sensor, such as a Charge Coupled Device (CCD) or a Complementary Metal Oxide Semiconductor (CMOS), along with various other components, such as a lens for controlling the formation of a subject image on the image sensor, and generates a captured image. The image capturing device may capture a still image, or may capture a moving image.

The sensor may be any of various sensors, such as, for example, a range sensor, an accelerometer, a gyro sensor, a geomagnetism sensor, a vibration sensor, a photosensor, a sound sensor, and the like. The sensor obtains information about the state of the information processing device 900 itself, such as the attitude of a housing of the information processing device 900, and information about the surrounding environment of the information processing device 900, such as light and noise around the information processing device 900. The sensor may also include a Global Positioning System (GPS) sensor that receives a GPS signal to measure the latitude, longitude, and altitude of the device.

The output device 917 is constituted by a device capable of visually or audibly notifying the user of obtained information. The output device 917 may be, for example, a display device such as a Liquid Crystal Display (LCD), an organic electroluminescence (EL) display, or the like, a sound output device such as a speaker or headphones, or the like. In addition, the output device 917 may include a Plasma Display Panel (PDP), a projector, a hologram, a printer device, or the like. The output device 917 outputs a result obtained by processing of the information processing device 900 as text or a video such as an image, or as a sound such as voice or acoustic sound. The output device 917 may also include an illumination device or the like that illuminates the surroundings.

The storage device 919 is a data storage device configured as an example of a storage unit of the information processing device 900. The storage device 919 is constituted by, for example, a magnetic storage device such as a Hard Disk Drive (HDD), a semiconductor storage device, an optical storage device, or a magneto-optical storage device. The storage device 919 stores programs executed by the CPU 901, various pieces of data, various pieces of data obtained from the exterior, and the like.

The drive 921 is a reader/writer for the removable recording medium 927, which is a magnetic disk, an optical disk, a magneto-optical disk, a semiconductor memory, or the like, and is built into or external to the information processing device 900. The drive 921 reads out information recorded in an attached removable recording medium 927, and outputs the information to the RAM 905. The drive 921 also writes records to the attached removable recording medium 927.

The connection port 923 is a port for connecting a device directly to the information processing device 900. The connection port 923 can be a Universal Serial Bus (USB) port, an IEEE 1394 port, a Small Computer System Interface (SCSI) port, or the like, for example. The connection port 923 may also be an RS-232C port, an optical audio terminal, a High-Definition Multimedia Interface (HDMI; registered trademark) port, or the like. Connecting the external connection device 929 to the connection port 923 enables the exchange of various types of data between the information processing device 900 and the external connection device 929.

The communication device 925 is a communication interface constituted by a communication device or the like for connecting to the network 40, for example. The communication device 925 can be a communication card for a wired or wireless Local Area Network (LAN), Bluetooth (registered trademark), Wi-Fi (registered trademark), Wireless USB (WUSB), or the like, for example. The communication device 925 may be a router for optical communication, a router for an Asymmetric Digital Subscriber Line (ADSL), or a modem for various types of communication. The communication device 925 sends and receives signals to and from the Internet or other communication devices using a predetermined protocol such as TCP/IP. Additionally, the network 40 connected to the communication device 925 is a network connected by wires or wirelessly, such as, for example, the Internet, a household LAN, infrared communication, radio wave communication, satellite communication, or the like.

### 7. SUPPLEMENTS

Although preferred embodiments of the present disclosure have been described in detail thus far with reference to the accompanying drawings, the technical scope of the present disclosure is not limited to such examples. It will be apparent that those having ordinary knowledge in the technical field of the present disclosure can conceive of many variations or modifications within the scope of the technical spirit set forth in the claims, and these should naturally be understood as falling within the technical scope of the present disclosure.

Further, the effects described in the present specification are merely explanatory or exemplary, and are not intended as limiting. In other words, the techniques according to the present disclosure may exhibit other effects apparent to those skilled in the art from the present descriptions, in addition to or instead of the above effects.

In addition, it is possible to create a computer program for causing hardware such as the CPU, ROM, and RAM provided in the distribution server 30 to implement functions equivalent to the configurations in the distribution server 30 described above. A non-transitory storage medium in which such a computer program is stored is also provided.

Note that configurations such as the following also fall within the technical scope of the present disclosure.

(1)

An information processing device including:
a communication unit that sends distribution content, provided by a distributor, to a plurality of user terminals;
a group selection unit that selects a first group, from among a plurality of groups to each of which two or more users belong, the first group being one group or two or more groups; and
a connection control unit that controls a connection to enable bidirectional communication between the users belonging to the first group and the distributor.
   (2)

The information processing device according to (1), further including: a virtual space generation unit that generates a virtual space in which user objects corresponding to users belonging to a same group are disposed,
wherein under control of the connection control unit, the communication unit sends, to a distributor terminal used by the distributor, information on the user objects corresponding to the users belonging to the first group.
   (3)

The information processing device according to (2),
wherein the communication unit sends the distribution content to user terminals used by the users, the distribution content including information on a distributor object corresponding to the distributor and disposed in the virtual space.
   (4)

The information processing device according to (1) or (3),
wherein the information on the user objects is updated based on motion information input to the user terminal, and
the communication unit receives the information on the user objects that has been updated.
   (5)

The information processing device according to any one of (1) to (4),
wherein under control of the connection control unit, the communication unit sends, to a distributor terminal used by the distributor, image information, audio information, or text information sent from the users belonging to the first group.
   (6)

The information processing device according to any one of (2) to (5),
wherein the group selection unit selects a second group from among a plurality of groups not selected as the first group by the group selection unit, the second group being one group or two or more groups, and
the connection control unit controls a connection such that communication among users belonging to the second group is conveyed to the distributor.
   (7)

The information processing device according to any one of (1) to (6),
wherein the group selection unit newly reselects the first group based on a predetermined condition.
   (8)

The information processing device according to (7),
wherein the predetermined condition is whether a group has been selected by the distributor, and
the group selection unit selects a group selected by the distributor as a new first group.
   (9)

The information processing device according to (7), further including:
a calculation unit that calculates an excitement level or a contribution level of each group in the plurality of groups based on the communication among users belonging to the same group,
wherein the predetermined condition is a condition pertaining to the excitement level or the contribution level calculated by the calculation unit.
   (10)

The information processing device according to any one of (1) to (9),
wherein a total number of the first groups selected by the group selection unit is a predetermined number.
   (11)

The information processing device according to (9),
wherein a total number of the first groups selected by the group selection unit is determined based on a calculation result from the calculation unit.
   (12)

The information processing device according to (3),
wherein when the first group is selected by the group selection unit, the virtual space generation unit generates a specific virtual space in which the distributor object and the user objects corresponding to the users belonging to the first group are disposed.
   (13)

The information processing device according to (3) or (12),
wherein the virtual space generation unit determines a location, in the virtual space, at which each of the user objects corresponding to the users belonging to the first group selected by the group selection unit are disposed, from among a plurality of types of locations having different experience values pertaining to communication with the distributor.
   (14)

The information processing device according to (13, further including:
a calculation unit that calculates an excitement level or a contribution level of each user belonging to the same group based on details of the communication among the users belonging to the same group,
wherein the virtual space generation unit determines the location based on the excitement level or the contribution level of each user calculated by the calculation unit.
   (15)

The information processing device according to any one of (1) to (14),
wherein the connection control unit determines a method of communication with the distributor for each of the users belonging to the first group selected by the group selection unit, from among a plurality of types of methods each having a different experience value for the communication with the distributor.
   (16)

The information processing device according to any one of (1) to (15),
wherein the communication unit receives, from each of the user terminals, information on the group to which the user using the user terminal belongs.
   (17)

An information processing method executed by a computer, the method including: distributing distribution content, provided by a distributor, to a plurality of user terminals;
selecting a first group, from among a plurality of groups to each of which two or more users belong, the first group being one group or two or more groups; and
controlling a connection to enable bidirectional communication between the users belonging to the first group and the distributor.
   (18)

A computer-readable non-transitory recording medium having recorded thereon a program for causing a computer to function as:
a distribution unit that distributes distribution content, provided by a distributor, to a plurality of user terminals;
a group selection unit that selects a first group, from among a plurality of groups to each of which two or more users belong, the first group being one group or two or more groups; and
a connection control unit that controls a connection to enable bidirectional communication between the users belonging to the first group and the distributor.

### REFERENCE SIGNS LIST

10 Distributor terminal
20 User terminal
30 Distribution server
40 Network
110 Communication unit
120 Control unit
130 Input unit
140 Output unit
150 Operation unit
210 Communication unit
220 Control unit
230 Input unit
240 Output unit
250 Operation unit
310 Communication unit
320 Control unit
321 Group selection unit
322 Calculation unit
323 Virtual space generation unit
324 Connection control unit
900 Information processing device

1. An information processing device comprising:
a communication unit that sends distribution content, provided by a distributor, to a plurality of user terminals;
a group selection unit that selects a first group, from among a plurality of groups to each of which two or more users belong, the first group being one group or two or more groups; and
a connection control unit that controls a connection to enable bidirectional communication between the users belonging to the first group and the distributor.

2. The information processing device according to claim 1, further comprising:
a virtual space generation unit that generates a virtual space in which user objects corresponding to users belonging to a same group are disposed,
wherein under control of the connection control unit, the communication unit sends, to a distributor terminal used by the distributor, information on the user objects corresponding to the users belonging to the first group.

3. The information processing device according to claim 2,
wherein the communication unit sends the distribution content to user terminals used by the users, the distribution content including information on a distributor object corresponding to the distributor and disposed in the virtual space.

4. The information processing device according to claim 2,
wherein the information on the user objects is updated based on motion information input to the user terminal, and
the communication unit receives the information on the user objects that has been updated.

5. The information processing device according to claim 1,
wherein under control of the connection control unit, the communication unit sends, to a distributor terminal used by the distributor, image information, audio information, or text information sent from the users belonging to the first group.

6. The information processing device according to claim 2,
wherein the group selection unit selects a second group from among a plurality of groups not selected as the first group by the group selection unit, the second group being one group or two or more groups, and
the connection control unit controls a connection such that communication among users belonging to the second group is conveyed to the distributor.

7. The information processing device according to claim 1,
wherein the group selection unit newly reselects the first group based on a predetermined condition.

8. The information processing device according to claim 7,
wherein the predetermined condition is whether a group has been selected by the distributor, and
the group selection unit selects a group selected by the distributor as a new first group.

9. The information processing device according to claim 7, further comprising:
a calculation unit that calculates an excitement level or a contribution level of each group in the plurality of groups based on the communication among users belonging to the same group,
wherein the predetermined condition is a condition pertaining to the excitement level or the contribution level calculated by the calculation unit.

10. The information processing device according to claim 1,
wherein a total number of the first groups selected by the group selection unit is a predetermined number.

11. The information processing device according to claim 9,
wherein a total number of the first groups selected by the group selection unit is determined based on a calculation result from the calculation unit.

12. The information processing device according to claim 3,
wherein when the first group is selected by the group selection unit, the virtual space generation unit generates a specific virtual space in which the distributor object and the user objects corresponding to the users belonging to the first group are disposed.

13. The information processing device according to claim 3,
wherein the virtual space generation unit determines a location, in the virtual space, at which each of the user objects corresponding to the users belonging to the first group selected by the group selection unit are disposed, from among a plurality of types of locations having different experience values pertaining to communication with the distributor.

14. The information processing device according to claim 13, further comprising:
a calculation unit that calculates an excitement level or a contribution level of each user belonging to the same group based on details of the communication among the users belonging to the same group,
wherein the virtual space generation unit determines the location based on the excitement level or the contribution level of each user calculated by the calculation unit.

15. The information processing device according to claim 1,
wherein the connection control unit determines a method of communication with the distributor for each of the users belonging to the first group selected by the group selection unit, from among a plurality of types of methods each having a different experience value for the communication with the distributor.

16. The information processing device according to claim 1,
wherein the communication unit receives, from each of the user terminals, information on the group to which the user using the user terminal belongs.

17. An information processing method executed by a computer, the method comprising:
distributing distribution content, provided by a distributor, to a plurality of user terminals;
selecting a first group, from among a plurality of groups to each of which two or more users belong, the first group being one group or two or more groups; and
controlling a connection to enable bidirectional communication between the users belonging to the first group and the distributor.

18. A computer-readable non-transitory recording medium having recorded thereon a program for causing a computer to function as:
a distribution unit that distributes distribution content, provided by a distributor, to a plurality of user terminals;
a group selection unit that selects a first group, from among a plurality of groups to each of which two or more users belong, the first group being one group or two or more groups; and
a connection control unit that controls a connection to enable bidirectional communication between the users belonging to the first group and the distributor.
